(19) United States
(12) Patent Application Publication
(10) Pub. No.: US 2014/0198084 A1
(43) Pub. Date: Jul. 17, 2014

(54) METHOD AND SYSTEM FOR DISPLAY BRIGHTNESS AND COLOR OPTIMIZATION

(71) Applicants: Stefan Peana, Austin, TX (US); Thomas P. Lanzoni, Cedar Park, TX (US)

(72) Inventors: Stefan Peana, Austin, TX (US); Thomas P. Lanzoni, Cedar Park, TX (US)

(21) Appl. No.: 13/743,206

(22) Filed: Jan. 16, 2013

(51) Int. Cl. G09G 3/34

(52) U.S. Cl. CPC G09G 3/3406
USPC 345/207

(57) ABSTRACT

Systems and methods for display brightness and color optimization include detecting, by a sensor communicatively coupled to a display, a change in an environmental brightness level. Additionally, in response to the change in the environmental brightness level, modifying a brightness level of the display and modifying a color gamut available to the display.

### TECHNICAL FIELD

The present disclosure relates in general to information handling systems, and more particularly to a method and system for display brightness and color optimization.

### BACKGROUND

As the value and use of information continues to increase, individuals and businesses seek additional ways to process and store information. One option available to users may be information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information may be handled, how the information may be handled, how much information may be processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications.

Information handling systems may include a variety of hardware and/or software components that may be configured to process, store, and/or communicate information. Liquid crystal displays (LCDs) may be used to display and communicate information. LCDs may modulate light to create images using selectively transmissive and opaque portions of the display by passing electrical current through the liquid crystal material. LCDs may use a backlight positioned behind the LCD glass to illuminate through a panel of pixels.

The LCD backlight may be one of the primary sources of power consumption in an information handling system. One way to control power consumption is to control the backlight brightness based on a range of criteria including idle time, environmental light level, or display content. However, when backlight brightness is controlled based on such criteria, the user may experience a sudden or soft change in the display brightness. The user may interpret the display brightness transition as intermittent display performance. Further, such changes may impact legibility of text and images may appear de-saturated.

### SUMMARY

In accordance with the teachings of the present disclosure, disadvantages and problems associated with liquid crystal display brightness and color optimization may be substantially reduced or eliminated.

In accordance with one embodiment of the present disclosure, a method is described for display brightness and color optimization that includes detecting, by a sensor communicatively coupled to a display, a change in an environmental brightness level. Additionally, in response to the change in the environmental brightness level, modifying a brightness level of the display and modifying a color gamut available to the display.

In accordance with another embodiment of the present disclosure, a display includes a processor configured to detect, by a sensor communicatively coupled to a display, a change in an environmental brightness level. Additionally, in response to the change in the environmental brightness level, the processor is configured to modify a brightness level of the display and modify a color gamut available to the display.

In accordance with another embodiment of the present disclosure, an information handling system includes a display, a sensor communicatively coupled to the display, and a processor communicatively coupled to the display and the sensor. The information handling system may further include a computer-readable medium communicatively coupled to the processor and having stored thereon instructions configured to, when executed by the processor, detect, by the sensor, a change in an environmental brightness level. Additionally, in response to the change in the environmental brightness level, the processor is configured to modify a brightness level of the display and modify a color gamut available to the display.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with certain embodiments of the present disclosure;

FIG. 2 illustrates an example xy chromaticity diagram for brightness and color optimization, in accordance with certain embodiments of the present disclosure; and

FIG. 3 illustrates a flow chart for an example method for display brightness and color optimization, in accordance with certain embodiments of the present disclosure.

### DETAILED DESCRIPTION

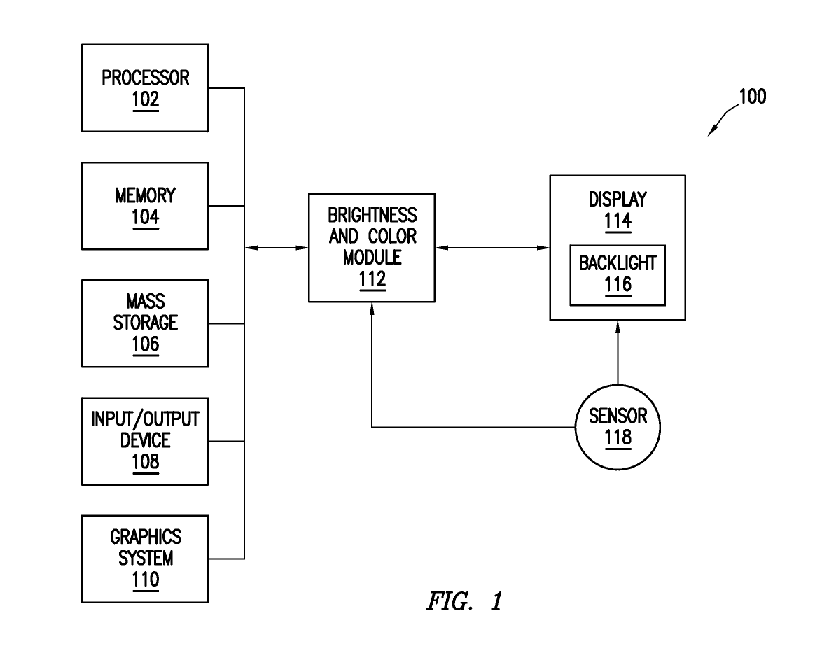

Preferred embodiments and their advantages are best understood by reference to FIGS. 1-3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage resource, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a block diagram of an example information handling system 100, in accordance with certain embodiments of the present disclosure. Information handling system 100 may generally be operable to receive data from, and/or transmit data to, other information handling systems 100. In one embodiment, information handling system 100 may be a desktop computer, laptop computer, mobile wireless device, wireless communication device, and/or any other suitable computing device. In the same or alternative embodiments, information handling system 100 may be a server or a storage array configured to include multiple storage resources (e.g., hard drives) in order to manage large amounts of data. In some embodiments, information handling system 100 may include, among other suitable components, processor 102, memory 104, mass storage device 106, input-output device 108, graphics system 110, brightness and color module 112, display 114, and sensor 118.

Processor 102 may include any system, device, or apparatus operable to interpret and/or execute program instructions and/or process data. Processor 102 may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored in memory 104, mass storage device 106, and/or another component of system 100.

Memory 104 may be communicatively coupled to processor 102 and may include any system, device, or apparatus operable to retain program instructions or data for a period of time (e.g., computer-readable media). Memory 104 may include random access memory (RAM), electrically erasable programmable read-only memory (EEPROM), flash memory, magnetic storage, opto-magnetic storage, or any suitable selection and/or array of volatile or non-volatile memory that retains data after power to system 100 may be removed.

Mass storage device 106 may include one or more storage resources (or aggregations thereof) communicatively coupled to processor 102 and may include any system, device, or apparatus operable to retain program instructions or data for a period of time (e.g., computer-readable media). Mass storage device 106 may retain data after power to system 100 may be removed. Mass storage device 106 may include one or more hard disk drives (HDDs), magnetic tape libraries, optical disk drives, magneto-optical disk drives, compact disk drives, compact disk arrays, disk array controllers, solid state drives (SSDs), and/or any computer-readable medium operable to store data.

Input-output device 108 may be communicatively coupled to processor 102 and may include any instrumentality or aggregation of instrumentalities by which a user may interact with system 100 and its various information handling resources by facilitating input from a user allowing the user to manipulate system 100 and output to a user allowing system 100 to indicate effects of the user's manipulation. For example, input-output device 108 may permit a user to input data and/or instructions into system 100 (e.g., via a keyboard, pointing device, and/or other suitable means), and/or otherwise manipulate system 100 and its associated components. In these and other embodiments, input-output device 108 may include other user interface elements (e.g., a keypad, buttons, and/or switches placed in proximity to a display) allowing a user to provide input to system 100.

Graphics system 110 may be communicatively coupled to processor 102 and may include any system, device, or apparatus operable to receive and process video information. Graphics system 110 may additionally be operable to transmit digital video information to display 114. Graphics system 110 may include any internal graphics capabilities including for example, but not limited to, integrated graphics or a graphics card. Graphics system 110 may include graphics drivers, graphics processors, and/or any other suitable components.

Display 114 may be communicatively coupled to processor 102 and may include any instrumentality or aggregation of instrumentalities to display information to a user. For example, display 114 may be a liquid crystal display (LCD), organic light-emitting diode (OLED) display, plasma display, and/or any other suitable display. Display 114 may include a display suitable for creating graphic images and/or alphanumeric characters recognizable to a user. In certain embodiments, display 114 may be an integral part of a chassis (not explicitly shown) and receive power from power supplies (not explicitly shown) of the chassis, rather than being coupled to the chassis via a cable. In some embodiments, display 114 may comprise a touch screen device capable of receiving user input, wherein a touch sensor may be mechanically coupled or overlaid upon the display and may comprise any system, apparatus, or device suitable for detecting the presence and/or location of a tactile touch, including, for example, a resistive sensor, capacitive sensor, surface acoustic wave sensor, projected capacitance sensor, infrared sensor, strain gauge sensor, optical imaging sensor, dispersive signal technology sensor, and/or acoustic pulse recognition sensor.

In some embodiments, display 114 may be a LCD and may include an inverter, a processor, and/or any other suitable components. A LCD may modulate light to create images using selectively transmissive and opaque portions of the display by passing electrical current through a liquid crystal material. Display 114 may include backlight 116. For example, backlight 116 may be any component of a LCD and may be configured to illuminate the liquid crystal material to provide a contrast between the light transmissive and opaque portions of the LCD. Backlight 116 may be a cool cathode florescent light (CCFL), several light emitting diodes (LEDs), an electroluminescent panel (ELP), or any other suitable device.

In some embodiments, the diversity of software applications executed by system 100 may require display 114 to display information at high resolutions with corresponding brightness and color gamut modifications. High resolution displays may impact overall system 100 performance due to the additional processing requirements. Moreover, backlight 116 may represent a primary source of power consumption in system 100. Therefore, optimization of both brightness and color for display 114 may be desired to maximize text and image legibility while taking into account the impact on overall system 100 power usage.

Display 114 may have a display surface that may include multiple pixels. Each pixel in display 114, e.g. a LCD, may include liquid crystal molecules suspended between two transparent electrodes that are in turn sandwiched between two polarizing filters whose axes of transmission may be perpendicular to each other. By applying voltage to the transparent electrodes over each pixel, the corresponding liquid crystal molecules may may allow varying degrees of light to pass through the polarizing filters. Each pixel may be composed of individual red, green, blue (RGB), and/or other color sub-pixels.

Sensor 118 may be communicatively coupled to display 114 and/or brightness and color module 112 and may include any system, device, or apparatus operable to sense light and/or color. Sensor 118 may be a device to detect brightness levels of ambient light proximate to and/or remote from display 114, such as an ambient light sensor (ALS). In some embodiments, sensor 118 may be a device to detect the color of ambient light proximate to and/or remote from display 114. In another embodiment, sensor 118 may be configured to detect both brightness and color of the ambient light proximate to and/or remote from display 114. For example, sensor 118 may be a component of a camera or video device proximate to and/or remote from display 114. In yet another embodiment, sensor 118 may be configured in a confined area, such as a conference room, and may detect brightness and/or color in a particular section of the confined area or room. Sensor 118 may be further configured to transmit the sensed information to display 114, brightness and color module 112, and/or any other suitable component of system 100.

Brightness and color module 112 may be communicatively coupled to display 114, processor 102, graphics system 110, sensor 118, and/or any other suitable component of system 100. In some embodiments, brightness and color module 112 may perform brightness and/or color adjustments that may be reflected in display 114. In some embodiments, brightness and color module 112 may be implemented in, for example, any application, process, script, module, executable, executable program, server, executable object, library, function, or other suitable digital entity. Brightness and color module 112 may include logic or instructions for execution by a processor such as processor 102. The logic of instructions of brightness and color module 112 may be resident within a memory 104 or mass storage device 106 communicatively coupled to processor 104.

Brightness and color module 112 may be implemented by any suitable software, hardware, firmware, or combination thereof configured as described herein. Brightness and color module 112 may be implemented by any suitable set of files, instructions, or other digital information. Brightness and color module 112 may include a set of files or other information making up, for example, a virtual machine installation such as an operating system, a virtual deployment environment or a secured module such as a secured browser. Brightness and color module 112 may include such an installation to be installed and configured in the same way among multiple of information handling system 100.

In some embodiments, brightness and color module 112 may be configured to control backlight 116 to manage processing and power consumption of display 114, e.g., a LCD. Backlight 116 may be controlled based on a range of criteria including idle time, e.g., amount of time since a user has interfaced with display 114, environmental light level (e.g., detected by sensor 118), content of application currently displayed on display 114, and/or any other suitable criteria. When backlight 116 is controlled based on such criteria, the user may experience a sudden or gradual change in the display brightness, which may impact the user experience. For example, if the environmental light detected by sensor 118 dims, brightness and color module 112 may cause backlight 116 to dim. The user may interpret such a change as an intermittent display quality performance, and/or the user may experience difficulty reading or viewing the content displayed on display 114. In some embodiments, when brightness is dimmed, the user's eye may perceive any text displayed on display 114 as darker and may perceive that image color becomes de-saturated. However, the optimal legibility of text may occur when contrast between the background and the text is maximized. Additionally, image legibility may be optimal when the colors are saturated. In some embodiments, maximized contrast for text and saturated colors for images may be achieved when both color and brightness are modified approximately simultaneously.

Further, the user's eye may perceive color most favorably at a particular illumination level. If illumination is increased above this level (e.g. brightness from backlight 116 is increased), the user's eye may perceive the colors displayed on display 114 as over-saturated. If illumination is decreased below this level (e.g., brightness from backlight 116 is decreased), the user's eye may perceive the colors as de-saturated. A balance may be defined between brightness and color such that a change in one may designate a similar change in the other. Thus, in order to provide an optimal user experience for readability, legibility, and eye comfort, while at the same time to optimize power consumption and battery life, it may be advantageous to modify both brightness and color approximately simultaneously.

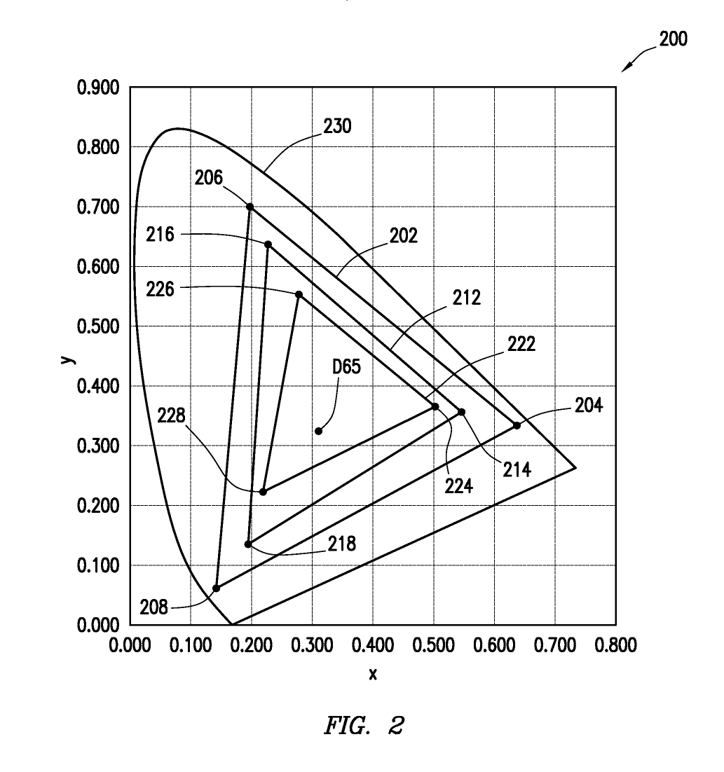

FIG. 2 illustrates an example xy chromaticity diagram 200 for brightness and color optimization, in accordance with certain embodiments of the present disclosure. Conceptually, color may be divided into two components: brightness and chromaticity. Chromaticity may be expressed through the use of a chromaticity diagram, such as chromaticity diagram 200. Chromaticity diagram 200 may be based on a xy color coordinate method for expressing a color by chromaticity coordinates x and y. Coordinates x and y may be derived from the tristimulus values (XYZ) of colors. Tristimulus values of a particular color may indicate the amount of the three primary colors, e.g., red, blue, and green, in a tri-chromatic additive color model that are present in the color. Coordinates x and y may be determined by the equations:

$$x = \frac{X}{X + Y + Z} , y = \frac{Y}{X + Y + Z} .$$

In some embodiments, curved boundary 230 may represent the entire range, or “gamut,” of colors that may be available for a display, such as display 114. Color gamuts 202, 212, and 222 may represent the edge of a particular range or gamut of colors available to and/or visible on a display. For example, color gamut 202 may be bounded by red primary 204, green primary 206, and blue primary 208. Color gamut 212 may be bounded by red primary 214, green primary 216, and blue primary 218. Color gamut 222 may be may be bounded by red primary 224, green primary 226, and blue primary 228. In some embodiments, D65 may be the point that commonly represents the color white.

In some embodiments, brightness and color module 112 may manage display 114 brightness and color approximately simultaneously. In operation, brightness and color module 112 may reduce the brightness of display 114 based upon a change in the environment and/or ambient light or brightness reaching sensor 118. Brightness and color module 112 may, approximately simultaneously, reduce proportionally the color gamut available to display images on display 114. For example, the color range or gamut may be reduced from color gamut 202 to color gamut 212. Thus, by reducing brightness and the available color gamut approximately simultaneously, the relationship between brightness and color that provides the optimal user visual experience may be maintained. As another example, brightness and color module 112 may increase the brightness of display 114 based upon a change in the environment and/or ambient light reaching sensor 118. Brightness and color module 112 may, approximately simultaneously, adjust the color gamut available to display images on display 114. For example, the color range or gamut may be adjusted from color gamut 222 to color gamut 212.

In some embodiments, each of color gamuts 202, 212, and 222 may be pre-defined by a user and/or a manufacturer. For example, color gamuts may be defined as standard red, green, and blue (sRGB), ADOBE RGB, and/or any other suitable defined color gamut. Color gamuts 202, 212, and 222 may be adjustable or may be fixed. Although only three color gamuts, e.g., color gamuts 202, 212, and 222, may be shown, more or fewer color gamuts may exist and may be defined. Further, although color gamuts are shown as a triangular shape with three vertices, any other suitable shape may be employed. For example, a quadrilateral or pentagon may be formed with vertices added for yellow and/or cyan.

In some embodiments, a set of look up tables (LUTs) may be generated that may contain color gamut values and associated brightness levels. For example, at a particular brightness level, the amount of red, green, and blue (RGB) to be displayed may be specified for sub-pixels in a LCD display. Further, brightness in the LUTs may be defined as luminance in units of nits. For example, there may be entries for RGB values in the LUTs in fifty nits increments, e.g., fifty nits, one hundred nits, one hundred and fifty nits, and/or other suitable values. The RGB values may represent a level of saturation and the three RGB values may be combined to determine the displayed color for a particular pixel. The values in the LUTs may be defined by a manufacturer or a user. Additionally, the values in the LUTs may be defined for different triggers. The triggers may include display 114 remaining idle for a preset period of time, system 100 entering hibernation mode, battery power level below a specified point, environmental conditions, and/or any other suitable criteria. For example, brightness and color module 112 may detect system 100 may be entering sleep or hibernation modes, or when sensor 118 and/or a system camera detects no user presence. As brightness levels decrease or increase or as a trigger occurs, the associated RGB values may be read from the LUTs. Interpolation methods may be used to determine RGB colors based on brightness levels not defined in the LUTs.

Additionally, in some embodiments, the LUTs may be defined for display 114 RGB values for a particular color gamut, such as color gamut 202. As brightness and color module 112 decreases the available color gamut, e.g., color gamut 212, a color processing algorithm may be employed to adjust the RGB values. The color processing algorithm may be based on non-liner or logarithmic functions. There are several color processing algorithms available that may be utilized with associated software, such as, eeColor produced by Entertainment Experience, LLC, Reno, Nev. For example, at a brightness of two hundred nits the RGB values based on color gamut 202 may be red of one hundred, green of one hundred fifty, and blue of two hundred. Utilizing a color processing algorithm, it may be determined that for color gamut 212 the RGB values at a brightness of two hundred nits may be red of one hundred and twenty, green of one hundred eighty, and blue of two hundred and fifty. If display 114 attempts to display a color outside of the defined color gamut, the color processing algorithm may be utilized to bring the color inside of the color gamut.

In some embodiments, brightness and color module 112 may adjust brightness and color based on the remaining battery level of a power supply. For example, if the battery charge or battery level of system 100 or the battery charge supplied to display 114 may be approaching depletion, e.g., less than twenty percent of battery remaining, brightness and color module 112 may reduce the brightness of display 114. Brightness and color module 112 may also adjust the available color gamut to maintain the balance that provides the optimal user experience. The adjustment of the available color gamut may correspond to an increase in available colors or a decrease in available colors based on the current brightness levels and environmental conditions. Thus, as brightness and color module 112 detects a low battery or low power level status, it may transition to a lower brightness and adjust the available color gamut. Such an adjustment, may attempt to extend system 100 working time while maintaining display front of screen performance (e.g., the user's eye may not perceive the brightness change).

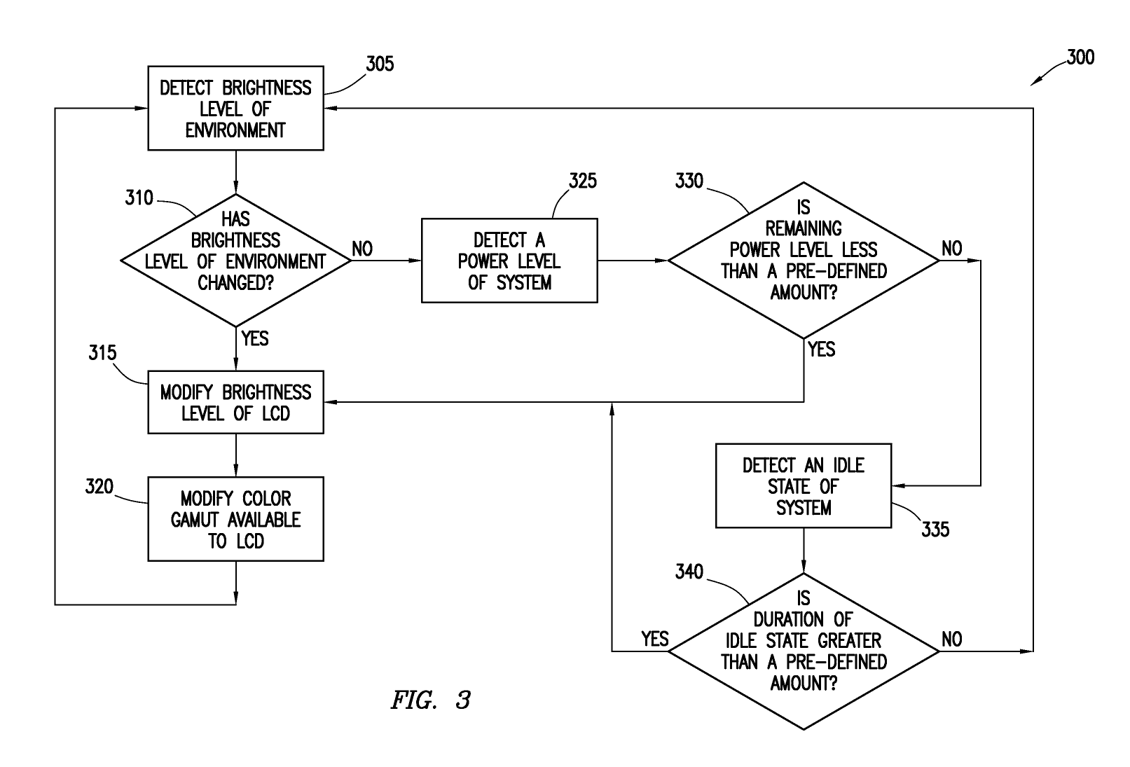

FIG. 3 illustrates a flow chart for an example method 300 for display 114 brightness and color optimization, in accordance with certain embodiments of the present disclosure. The steps of method 300 may be performed by various computer programs, models or any combination thereof. The programs and models may include instructions stored on a computer-readable medium and operable to perform, when executed, one or more of the steps described below. The computer-readable medium may include any system, apparatus or device configured to store and/or retrieve programs or instructions such as a microprocessor, a memory, a disk controller, a compact disc, flash memory or any other suitable device. The programs and models may be configured to direct a processor or other suitable unit to retrieve and/or execute the instructions from the computer readable media. For example, method 300 may be executed by processor 102, graphics system 114, brightness and color module 112, a user, and/or other suitable source. For illustrative purposes, method 300 may be described with respect to display 114 of FIG. 1; however, method 300 may be used for brightness and color optimization of any suitable display or LCD.

Although FIG. 3 discloses a particular number of steps to be taken with respect to method 300, method 300 may be executed with greater or lesser steps than those depicted in FIG. 3. In addition, although FIG. 3 discloses a certain order of steps to be taken with respect to method 300, the steps comprising method 300 may be completed in any suitable order.

At step 305, method 300 may detect the brightness level of the environment proximate to or remote from a display, such as display 114. For example, sensor 118, e.g., an ALS, may be used to detect the brightness level directly in front of display 114. Sensor 118 may detect multiple brightness readings. At step 310, method 300 may determine if the environmental brightness level has changed from a previous reading.

If the environmental brightness level has changed, then, at step 315 the brightness of the display may be modified. For example, if the environmental brightness has decreased, the brightness of display 114 may be adjusted. In some embodiments, sensor 118 may be constantly detecting the brightness level and every subtle change may not be directly reflected in the brightness level of the display. The changes to brightness level of the display may be delayed by a delay factor to improve the user experience and display the change gradually.

At step 320, method 300 may modify the color gamut available to display 114 appropriate to the change in brightness level of display 114. For example, if the brightness of display 114 is reduced, then the color gamut available to display 114 may be adjusted accordingly, e.g., from color gamut 202 to color gamut 212 as discussed with reference to FIG. 2. If, at step 315, the brightness of display 114 is increased, the color gamut available to display 114 may also be adjusted accordingly, e.g., from color gamut 212 to color gamut 202. Steps 315 and 320 may be based on pre-defined LUTs or LUTs derived from a color processing algorithm. In some embodiments, the LUTs may be defined for display 114 RGB values for a particular color gamut, such as color gamut 202. As the brightness level of display 114 changes, the LUTs may be consulted to determine values for the corresponding RGB values. For example, as the available color gamut decreases, e.g., from color gamut 202 to color gamut 212, a color processing algorithm may be employed to adjust the RGB values. For example, at brightness level of two hundred nits the RGB values based on color gamut 202 may be red of one hundred, green of one hundred fifty, and blue of two hundred. Utilizing a color processing algorithm, it may be determined that for color gamut 212 the RGB values at a brightness level of two hundred nits the may be red of one hundred and twenty, green of one hundred eighty, and blue of two hundred and fifty. If display 114 attempts to display a color outside of the defined color gamut, the color processing algorithm may be utilized to bring the color inside of the color gamut.

However, if at step 310 there is no detected change in environmental brightness, then method 300 may detect the power level of a power supply of the system, e.g., the battery level. For example, the method may detect the power level of a power supply associated with system 100 shown in FIG. 1. At step 330, method 300 may determine if the remaining power level is less than a pre-defined amount. For example, if the remaining power level is below a pre-defined percentage, e.g., less than twenty percent of battery power remaining, then method 300 may proceed to step 315. If the power level is not below a pre-defined amount method 300 may proceed to step 335. or if the idle time of the system is less than a pre-defined duration,

At step 335, method 300 may detect an idle state such that the user has not interacted with the display for a period of time. For example, the method may determine the idle time of system 100. At step 340, method 300 may determine if the the idle time duration is greater than a pre-defined amount, and if so, proceed to step 315. If the idle time is less than a pre-defined amount, method 300 may proceed to step 305.

Modifications, additions, or omissions may be made to method 300 without departing from the scope of the present disclosure. For example, the order of the steps may be performed in a different manner than that described and some steps may be performed at the same time. For example, step 315 and step 320 may be performed simultaneously. Additionally, each individual step may include additional steps without departing from the scope of the present disclosure. For example, step 325 may be preformed before or after step 305 without departing from the scope of the present disclosure.

Although the present invention and its advantages have been described in detail, it should be understood that various changes, substitutions and alternations can be made herein without departing from the spirit and scope of the invention as defined by the following claims.

What is claimed is:

1. A method for display brightness and color optimization comprising:
detecting, by a sensor communicatively coupled to a display, a change in an environmental brightness level; and
in response to the change in the environmental brightness level, modifying a brightness level of the display and modifying a color gamut available to the display.

2. The method of claim 1, wherein modifying the color gamut available to the display comprises adjusting the color gamut based on a reduction in the brightness level of the display.

3. The method of claim 1, wherein modifying the color gamut available to the display comprises adjusting the color gamut based on an increase in the brightness level of the display.

4. The method of claim 1, further comprising:
detecting that a power level of a power supply communicatively coupled to the display is below a pre-defined amount; and
decreasing the brightness level of the display and adjusting the color gamut available to the display.

5. The method of claim 1, wherein the display is a liquid crystal display.

6. The method of claim 5, wherein modifying the brightness level and modifying the color gamut is based on values of red, green, and blue (RGB) saturation in a look up table.

7. The method of claim 6, wherein the values of RGB saturation are based on a color processing algorithm.

8. The method of claim 1, wherein the sensor is a camera.

9. The method of claim 1, wherein the sensor is located remotely from the display.

10. The method of claim 1, wherein the sensor is located proximate to the display.

11. A display comprising:
a processor configured to:
detect, by a sensor communicatively coupled to a display, a change in an environmental brightness level; and
in response to the change in the environmental brightness level, modify a brightness level of the display and modify a color gamut available to the display.

12. The display system of claim 11, wherein modifying the color gamut available to the display comprises adjusting the color gamut based on a reduction in the brightness level of the display

13. The display system of claim 11, wherein modifying the color gamut available to the display comprises adjusting the color gamut based on an increase in the brightness level of the display.

14. The display system of claim 11, wherein the processor if further configured to:
detect that a power level of a power supply communicatively coupled to the display is below a pre-defined amount; and
decrease the brightness level of the display and adjust the color gamut available to the display.

15. The display system of claim 11, wherein the display is a liquid crystal display.

16. The display system of claim 11, wherein the sensor is located remotely from the display.

17. An information handling system comprising:
a display;
a sensor communicatively coupled to the display;
a processor communicatively coupled to the display and the sensor; and
a computer-readable medium communicatively coupled to the processor and having stored thereon instructions configured to, when executed by the processor:
detect, by the sensor, a change in an environmental brightness level; and
in response to the change in the environmental brightness level, modify a brightness level of the display and modify a color gamut available to the display.

18. The system of claim 17, wherein modifying the color gamut available to the display comprises adjusting the color gamut based on a reduction in the brightness level of the display.

19. The system of claim 17, wherein modifying the color gamut available to the display comprises adjusting the color gamut based on an increase in the brightness level of the display.

20. The system of claim 17, wherein the wherein the sensor is located remotely from the display.
